(19) United States
(12) Patent Application Publication
(10) Pub. No.: US 2011/0307252 A1
(43) Pub. Date: Dec. 15, 2011

(54) Using Utterance Classification in Telephony and Speech Recognition Applications

(75) Inventors: Yun-Cheng Ju, Bellevue, WA (US); James Garnet Droppo, III, Carnation, WA (US)

(73) Assignee: MICROSOFT CORPORATION, Redmond, WA (US)

(21) Appl. No.: 12/815,419

(22) Filed: Jun. 15, 2010

(51) Int. Cl. G10L 15/08

(52) U.S. Cl. 704/232; 704/E15.014

(57) ABSTRACT

Described is the use of utterance classification based methods and other machine learning techniques to provide a telephony application or other voice menu application (e.g., an automotive application) that need not use Context-Free-Grammars to determine a user's spoken intent. A classifier receives text from an information retrieval-based speech recognizer and outputs a semantic label corresponding to the likely intent of a user's speech. The semantic label is then output, such as for use by a voice menu program in branching between menus. Also described is training, including training the language model from acoustic data without transcriptions, and training the classifier from speech-recognized acoustic data having associated semantic labels.

### BACKGROUND

To recognize and understand the intention of the callers, telephony applications and the like e.g., a “voice menu” system typically use Context-Free-Grammars. In general, Context-Free-Grammars are data that basically provide a specific list of sentences/phrases for which the telephony application listens. When a caller speaks an utterance, a matching sentence/phrase is selected based on weighted parameters and the like, or the caller asked to repeat the utterance if no matching sentence/phrase is found.

While a Context-Free-Grammars approach is relatively easy and inexpensive to implement, using this approach suffers from a number of problems. For one, disfluencies in speech input are not effectively handled. For another, there is a practical problem of pronunciation mismatch. Users are often unsatisfied and frustrated with voice menu systems because of being given wrong selections or having to repeat the same speech over and over.

Further, Context-Free-Grammars are only as good as the list, which is difficult to put together. For example, even though there is often a very large volume of data corresponding to a very large number of calls for a telephony application, much of it cannot be used, because manual transcriptions are needed, e.g., on the order of tens of thousands for a single top-level voice menu to handle the large number of variations. After a point, the performance does not improve by any significant amount simply by adding new phrases and/or adjusting the parameter weights.

### SUMMARY

This Summary is provided to introduce a selection of representative concepts in a simplified form that are further described below in the Detailed Description. This Summary is not intended to identify key features or essential features of the claimed subject matter, nor is it intended to be used in any way that would limit the scope of the claimed subject matter.

Briefly, various aspects of the subject matter described herein are directed towards a technology by which a classifier, which is trained with speech-recognized acoustic data having associated semantic label, is configured to classify speech-recognized text into a semantic label of a predetermined set of such labels. The semantic label is then output, such as for use by a voice menu program in branching between menus, e.g., a telephony application or an automotive application.

In one aspect, the speech recognizer is an utterance classification-based speech recognizer having a statistical language model iteratively trained on labeled training data, (as well as possibly on non-labeled data). The speech recognizer and/or the classifier may operate at a phoneme-level, a word-level, or other sub-unit level. As will be understood, the technology also includes the capability to use transcribed data, non-transcribed data with semantic labels, and non-transcribed, non-labeled (blind) data to improve results.

Other advantages may become apparent from the following detailed description when taken in conjunction with the drawings.

### BRIEF DESCRIPTION OF THE DRAWINGS

The present invention is illustrated by way of example and not limited in the accompanying figures in which like reference numerals indicate similar elements and in which:

FIG. 1 is a block/flow diagram representing a training phrase for training a statistical language model for speech recognition and a classification model used for classifying speech-recognized text into a semantic label.

FIG. 2 is block/flow diagram representing a classification phrase in which an input query utterance is recognized as text which is then used by a classifier for outputting a semantic label.

FIG. 3 shows an illustrative example of a computing environment into which various aspects of the present invention may be incorporated.

### DETAILED DESCRIPTION

Various aspects of the technology described herein are generally directed towards using an information retrieval approach and a classifier to understand a speaker's intent regarding what the speaker said, by matching with and/or mapping recognized speech into a cluster of logged classification samples to obtain a semantic label. Performance improves as the search space (database) becomes more complete and more training samples become available. As will be understood, the technology uses data-driven techniques to bypass the Context-Free-Grammars approach to provide higher performance (user satisfaction) at a lower development/maintenance cost.

It should be understood that any of the examples herein are non-limiting. As such, the present invention is not limited to any particular embodiments, aspects, concepts, structures, functionalities or examples described herein. Rather, any of the embodiments, aspects, concepts, structures, functionalities or examples described herein are non-limiting, and the present invention may be used in various ways that provide benefits and advantages in computing and classification in general.

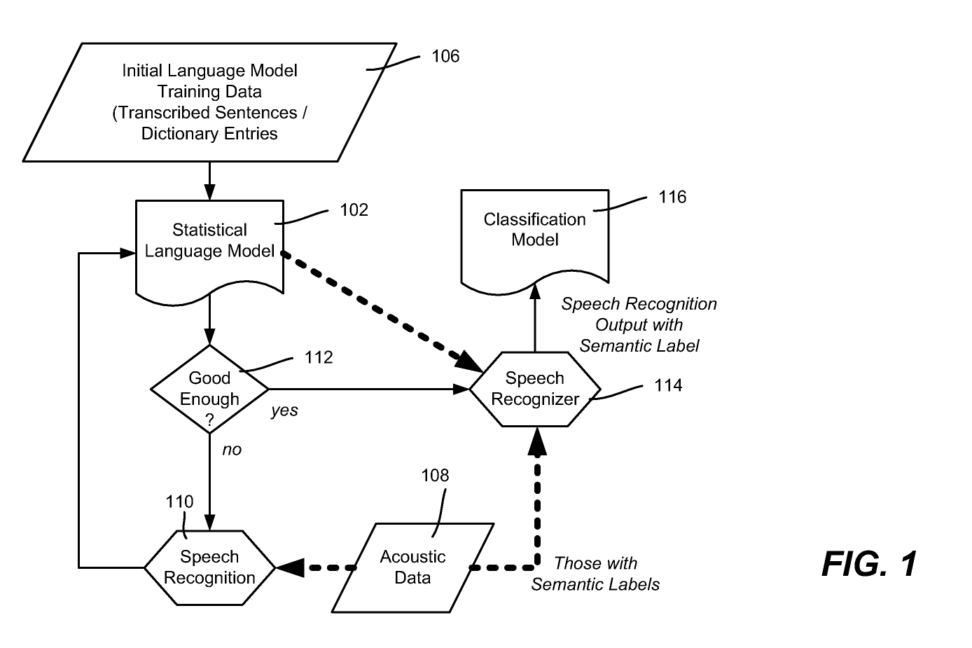

FIG. 1 is a block diagram showing a training phase for machine-learning/training a statistical language model 102 and classification model 104. An initial language model 106 comprising training data (e.g., transcribed sentences and/or dictionary entries on the order of thousands) is used in conjunction with acoustic data 108 to develop the statistical language model 102 used for speech recognition 110.

U.S. patent application Ser. No. 12/722,556, assigned to the assignee of the present application and hereby incorporated by reference, generally describes the use of information retrieval-based methods to convert speech into a recognition result (text). For example, an utterance may be converted to phonemes or sub-word units, which are then divided into various possible segments. The segments are then measured against word labels based upon TF-IDF or other features, for example, to find acoustic scores for possible words of the utterance. The acoustic scores may be used in various hypotheses along with a length score and a language model score to rank candidate phrases for the utterance. Training is based on creating an acoustic units-to-text data matrix (analogous to a term-document matrix) over the appropriate features. Minimum classification error techniques or other techniques may be used to train the parameters of the routing matrix.

Note that traditional speech recognition works on either the word or the phone level. However, an alternative mixed-level voice search implementation may use word-level transcriptions from the training sentences and automatically generate phone-level training sentences from the speech recognition output. Such phone-level recognition units tend to capture disfluency and reduce pronunciation mismatch relative to only using word-level units. For example, “Indiana” may be pronounced “Inny Ana” which are not words; however by operating at a phoneme-level both utterances may be mapped to a semantic label such as “destination.”

In general, the training process iterates, with the speech recognition results evaluated against the labeled training data until the statistical language model 102 is deemed sufficiently good (decision diamond 112); four or five iterations may suffice, for example. Such iterative language model training encourages more consistent speech recognition output, which in turns improves the classification accuracy. It also enables the use of non-transcribed acoustic data to be used to improve the language model.

Some of the acoustic data 108 are associated with semantic tags (e.g., one million out of two million units may have tags). More particularly, observed utterances are grouped into clusters based on their semantic concepts (e.g., the voice menu's branches). Those with tags are run through a speech recognizer 114 (e.g., corresponding to the recognition process in the iterative training) with the recognition results used to train a classifier.

The recognition results, in conjunction with the semantic tags, are used to train a classification model 116. A typical number of semantic labels is on the order of a dozen or two, and while the number of semantic labels is predetermined based upon those needed for an application, the number may change as new features or the like are added to the application. For example, a “voice menu” task is cast as a semantic classification (voice search) task using the training sentences to see which cluster most closely represents an input query, which then may be mapped to a specific menu. Because the classifier takes text, new menu options may be added without needing actual training utterances, e.g., by using artificial examples entered as text by the system designers.

Transcribed data, non-transcribed but categorized data (that is, what the user wants is known, however the exact words spoken are not known), and complete blind data (non-transcribed, non-characterized data, i.e., neither the transcription nor the category is known) may be used to improve the statistical language model 102 and/or the classification model 116. To this end, a semi-supervised method (labeling and/or transcription is provided for part of the data while the remaining data is unlabeled and/or non-transcribed) may be used in a performance tuning phase to achieve continued performance improvement in language model tuning and classifier tuning at relatively very low cost. For example, in the partially labeled case, semantic labels may be regenerated by the classification module for reuse in training; these may be weighted (or threshholded) by some confidence measure, with only high-confidence data is used for the subsequent learning. It is also possible to weight all of the data equally. For the unlabeled case, it is possible to iterate the language model (and transcriptions) until convergence, and then iterate the classification (and semantic labels) until convergence; it is also possible to interleave the language model and classification updates. Using transcription from speech recognition on otherwise non-transcribed data (e.g., instead of manual transcription) improves the quality of the language model.

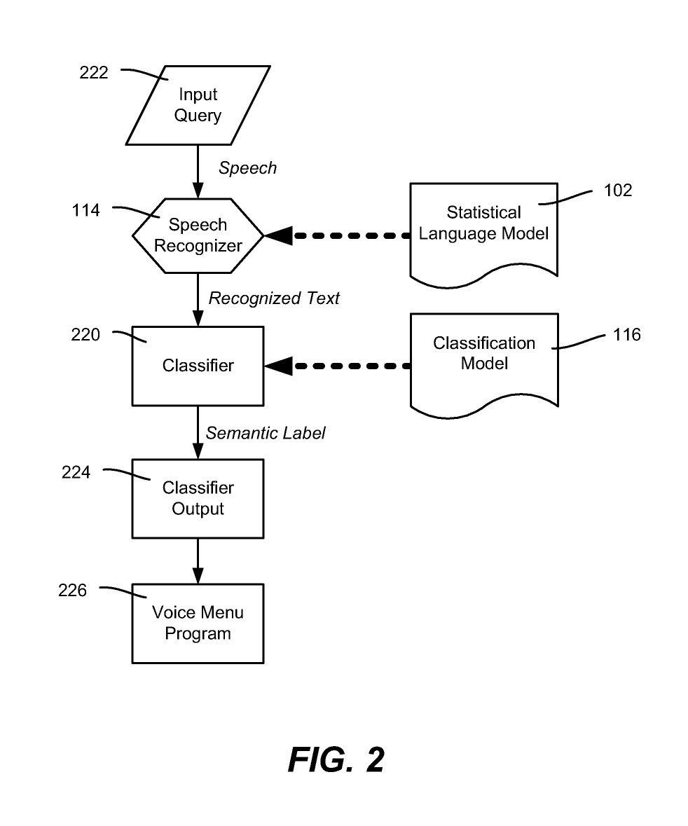

FIG. 2 represents the online usage of the speech recognizer 114 based upon the statistical language model 102, and the classifier 220 based upon the classification model 116. When an input query 222 is received as speech, the speech recognizer 114 converts the speech to recognized text, which is then fed into the classifier 220. The classifier output 224 (result) is one of the clusters/semantic tags that corresponds to the speech, and thus for example, may be used by a voice menu program 226 such as to branch to a different menu that corresponds to the semantic label. Note that any speech recognition technology may be used, however one which is trained via information retrieval-based methods has been found to provide advantages.

By way of example, consider a top-level voice menu in an automotive application scenario. Semantic tags such as “directions”, “destination,” “help”, “phone” and so forth may be the classification classes for that menu. When a user speaks to say something like “I need to know my options” and thereby provides the acoustic data, the classifier 220 receives corresponding recognized text and determines that this speech belongs to the “help” class. From there, the application can provide an appropriate verbal response (e.g., “are you asking for help?”) and/or take an appropriate action, e.g., branch to a Help menu.

In one implementation, the classifier 220 need not be limited to only a single output class, but instead may generate n-Best ranked results (or results with associated likelihood data), such as when given an imprecise query. These may be used to provide a more helpful and productive confirmation. For example the speech recognizer may hear “turn-by-turn driving directions” which the classifier may decide may match two classes reasonably well (e.g., both around fifty percent probability), and thus the user may be asked in return “Do you want a next turn notification or driving directions to a new destination?” with the user's response then received and matched to the desired class. Also note that if no semantic label has a high enough probability, or if a label comes back as an “unknown” classification or the like, a “Sorry, I did not understand you” or other suitable prompt may be given to the user.

### Exemplary Operating Environment

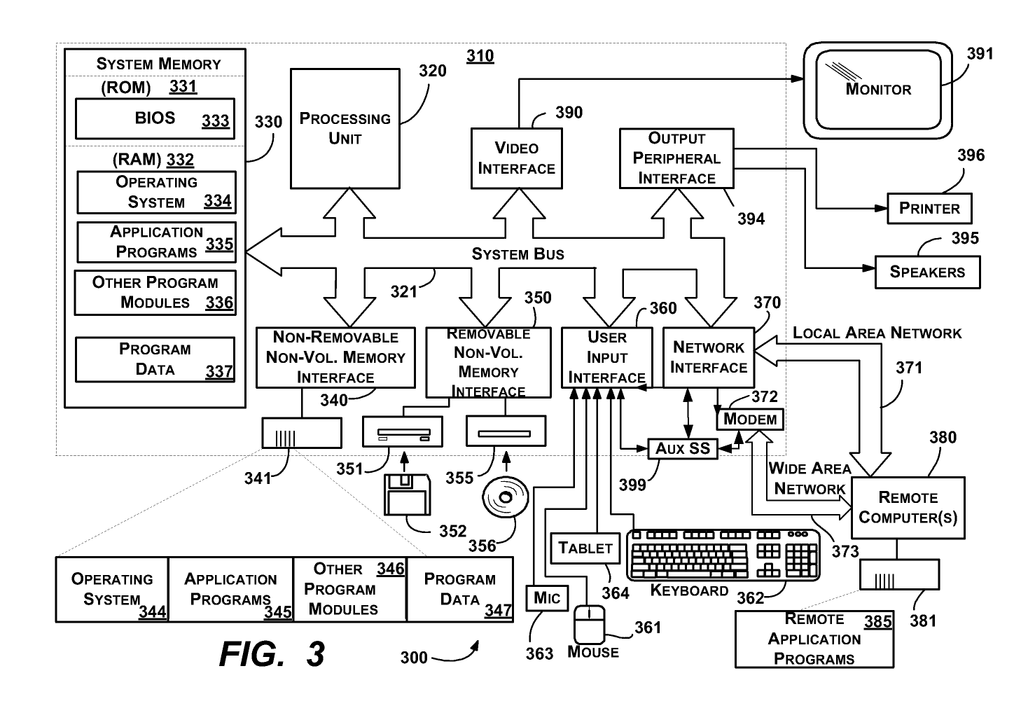

FIG. 3 illustrates an example of a suitable computing and networking environment 300 on which the examples of FIGS. 1 and 2 may be implemented. The computing system environment 300 is only one example of a suitable computing environment and is not intended to suggest any limitation as to the scope of use or functionality of the invention. Neither should the computing environment 300 be interpreted as having any dependency or requirement relating to any one or combination of components illustrated in the exemplary operating environment 300.

The invention is operational with numerous other general purpose or special purpose computing system environments or configurations. Examples of well-known computing systems, environments, and/or configurations that may be suitable for use with the invention include, but are not limited to: personal computers, server computers, hand-held or laptop devices, tablet devices, multiprocessor systems, microprocessor-based systems, set top boxes, programmable consumer electronics, network PCs, minicomputers, mainframe computers, distributed computing environments that include any of the above systems or devices, and the like.

The invention may be described in the general context of computer-executable instructions, such as program modules, being executed by a computer. Generally, program modules include routines, programs, objects, components, data structures, and so forth, which perform particular tasks or implement particular abstract data types. The invention may also be practiced in distributed computing environments where tasks are performed by remote processing devices that are linked through a communications network. In a distributed computing environment, program modules may be located in local and/or remote computer storage media including memory storage devices.

With reference to FIG. 3, an exemplary system for implementing various aspects of the invention may include a general purpose computing device in the form of a computer 310. Components of the computer 310 may include, but are not limited to, a processing unit 320, a system memory 330, and a system bus 321 that couples various system components including the system memory to the processing unit 320. The system bus 321 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

The computer 310 typically includes a variety of computer-readable media. Computer-readable media can be any available media that can be accessed by the computer 310 and includes both volatile and nonvolatile media, and removable and non-removable media. By way of example, and not limitation, computer-readable media may comprise computer storage media and communication media. Computer storage media includes volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by the computer 310. Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above may also be included within the scope of computer-readable media.

The system memory 330 includes computer storage media in the form of volatile and/or nonvolatile memory such as read only memory (ROM) 331 and random access memory (RAM) 332. A basic input/output system 333 (BIOS), containing the basic routines that help to transfer information between elements within computer 310, such as during start-up, is typically stored in ROM 331. RAM 332 typically contains data and/or program modules that are immediately accessible to and/or presently being operated on by processing unit 320. By way of example, and not limitation, FIG. 3 illustrates operating system 334, application programs 335, other program modules 336 and program data 337.

The computer 310 may also include other removable/non-removable, volatile/nonvolatile computer storage media. By way of example only, FIG. 3 illustrates a hard disk drive 341 that reads from or writes to non-removable, nonvolatile magnetic media, a magnetic disk drive 351 that reads from or writes to a removable, nonvolatile magnetic disk 352, and an optical disk drive 355 that reads from or writes to a removable, nonvolatile optical disk 356 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 341 is typically connected to the system bus 321 through a non-removable memory interface such as interface 340, and magnetic disk drive 351 and optical disk drive 355 are typically connected to the system bus 321 by a removable memory interface, such as interface 350.

The drives and their associated computer storage media, described above and illustrated in FIG. 3, provide storage of computer-readable instructions, data structures, program modules and other data for the computer 310. In FIG. 3, for example, hard disk drive 341 is illustrated as storing operating system 344, application programs 345, other program modules 346 and program data 347. Note that these components can either be the same as or different from operating system 334, application programs 335, other program modules 336, and program data 337. Operating system 344, application programs 345, other program modules 346, and program data 347 are given different numbers herein to illustrate that, at a minimum, they are different copies. A user may enter commands and information into the computer 310 through input devices such as a tablet, or electronic digitizer, 364, a microphone 363, a keyboard 362 and pointing device 361, commonly referred to as mouse, trackball or touch pad. Other input devices not shown in FIG. 3 may include a joystick, game pad, satellite dish, scanner, or the like. These and other input devices are often connected to the processing unit 320 through a user input interface 360 that is coupled to the system bus, but may be connected by other interface and bus structures, such as a parallel port, game port or a universal serial bus (USB). A monitor 391 or other type of display device is also connected to the system bus 321 via an interface, such as a video interface 390. The monitor 391 may also be integrated with a touch-screen panel or the like. Note that the monitor and/or touch screen panel can be physically coupled to a housing in which the computing device 310 is incorporated, such as in a tablet-type personal computer. In addition, computers such as the computing device 310 may also include other peripheral output devices such as speakers 395 and printer 396, which may be connected through an output peripheral interface 394 or the like.

The computer 310 may operate in a networked environment using logical connections to one or more remote computers, such as a remote computer 380. The remote computer 380 may be a personal computer, a server, a router, a network PC, a peer device or other common network node, and typically includes many or all of the elements described above relative to the computer 310, although only a memory storage device 381 has been illustrated in FIG. 3. The logical connections depicted in FIG. 3 include one or more local area networks (LAN) 371 and one or more wide area networks (WAN) 373, but may also include other networks. Such networking environments are commonplace in offices, enterprise-wide computer networks, intranets and the Internet.

When used in a LAN networking environment, the computer 310 is connected to the LAN 371 through a network interface or adapter 370. When used in a WAN networking environment, the computer 310 typically includes a modem 372 or other means for establishing communications over the WAN 373, such as the Internet. The modem 372, which may be internal or external, may be connected to the system bus 321 via the user input interface 360 or other appropriate mechanism. A wireless networking component such as comprising an interface and antenna may be coupled through a suitable device such as an access point or peer computer to a WAN or LAN. In a networked environment, program modules depicted relative to the computer 310, or portions thereof, may be stored in the remote memory storage device. By way of example, and not limitation, FIG. 3 illustrates remote application programs 385 as residing on memory device 381. It may be appreciated that the network connections shown are exemplary and other means of establishing a communications link between the computers may be used.

An auxiliary subsystem 399 (e.g., for auxiliary display of content) may be connected via the user interface 360 to allow data such as program content, system status and event notifications to be provided to the user, even if the main portions of the computer system are in a low power state. The auxiliary subsystem 399 may be connected to the modem 372 and/or network interface 370 to allow communication between these systems while the main processing unit 320 is in a low power state.

### CONCLUSION

While the invention is susceptible to various modifications and alternative constructions, certain illustrated embodiments thereof are shown in the drawings and have been described above in detail. It should be understood, however, that there is no intention to limit the invention to the specific forms disclosed, but on the contrary, the intention is to cover all modifications, alternative constructions, and equivalents falling within the spirit and scope of the invention.

What is claimed is:

1. In a computing environment, a method performed on at least one processor comprising:
inputting text into a classifier that was trained with speech-recognized acoustic data having associated semantic labels;
classifying the text into one or more of the semantic labels; and
outputting the one or more semantic labels from the classifier.

2. The method of claim 1 inputting the text comprises receiving speech input comprising an utterance and recognizing the utterance as the text.

3. The method of claim 2 wherein the recognizing the utterance comprises inputting the utterance into an information retrieval-based speech recognizer.

4. The method of claim 3 further comprising, training the information retrieval-based speech recognizer with transcribed data, non-transcribed characterized data or non-transcribed, non-characterized data, or any combination of transcribed data, non-transcribed, characterized data or non-transcribed, non-characterized data.

5. The method of claim 1 wherein the semantic label corresponds to a menu of a voice menu system, and further comprising, branching to that menu.

6. The method of claim 1 wherein the classifier outputs a plurality of semantic labels, and further comprising, using the plurality of semantic labels to request a confirmation as to which one of the plurality of semantic labels is correct.

7. The method of claim 1 further comprising, training the classifier with phone-level training data generated from a word-level transcription.

8. The method of claim 1 further comprising, training the classifier with artificial examples entered as text.

9. The method of claim 1 further comprising, training the classifier with transcribed data, non-transcribed, characterized data or non-transcribed, non-characterized data, or any combination of transcribed data, non-transcribed, characterized data or non-transcribed, non-characterized data.

10. In a computing environment, a system comprising, a voice-menu program, the voice menu program coupled to a classifier trained at least in part via machine learning using data associated with semantic labels of a predetermined set of semantic labels, the classifier configured to input text received from a speech recognizer and search a classification model to match at least one semantic label to the text for providing to the voice menu program.

11. The system of claim 10 where the voice menu program corresponds to a telephony application.

12. The system of claim 10 where the voice menu program corresponds to an automotive application.

13. The system of claim 10 wherein the voice menu program changes a menu based upon a semantic label provided by the classifier.

14. The system of claim 10 wherein the classifier provides two or more semantic labels, and wherein the voice menu program prompts for verbal confirmation corresponding to which of the semantic labels is to be used in taking further action.

15. The system of claim 10 wherein the speech recognizer comprises an information retrieval-based speech recognizer having a statistical language model iteratively trained at least in part on labeled training data.

16. The system of claim 10 wherein the speech recognizer or the classifier, or both the speech recognizer and the classifier, operate at a phoneme-level, a word-level, or other sub-unit level, or any combination of a phoneme-level, a word-level, or other sub-unit level.

17. One or more computer-readable media having computer-executable instructions, which when executed perform steps, comprising, classifying text into a semantic label of a predetermined set of semantic labels, in which the text corresponds to recognized speech, selecting a menu of a voice menu program based upon the semantic label, and changing the voice menu program to the selected menu.

18. The one or more computer-readable media of claim 17 having further computer-executable instructions comprising, recognizing the text from an utterance via an information retrieval-based speech recognizer.

19. The one or more computer-readable media of claim 17 having further computer-executable instructions comprising, classifying other text into a plurality of the semantic labels, and using the plurality of semantic labels to request a confirmation as to which one of the plurality of semantic labels is correct.

20. The one or more computer-readable media of claim 17 having further computer-executable instructions comprising, training the classifier with phone-level training data generated from a word-level transcription.
